(19) United States
(12) Patent Application Publication
(10) Pub. No.: US 2012/0298467 A1
(43) Pub. Date: Nov. 29, 2012

(54) TORQUE TRANSFER DEVICE HAVING REDUCED TORQUE VARIATION

(75) Inventors: Gerhard Bellinger, Muhlhausen (DE); Jörg Molz, Bensheim (DE); Sven Pinzl, Tambach-Dietharz (DE)

(73) Assignee: BORGWARNER, INC., Auburn Hills, MI (US)

(21) Appl. No.: 13/444,103

(22) Filed: Apr. 11, 2012

Related U.S. Application Data
(63) Continuation-in-part of application No. 12/179,120, filed on Jul. 24, 2008.
(60) Provisional application No. 60/953,237, filed on Aug. 1, 2007.

(51) Int. Cl. F16D 15/00; F16D 28/00

(52) U.S. Cl. 192/84.92

(57) ABSTRACT

An electrically actuated torque transfer device including an input shaft and at least one output shaft selectively coupled to the input shaft. At least one modulating clutch assembly selectively couples the input shaft to the output shaft. The modulating clutch assembly includes an electrical clutch operator configured to engage a ball ramp operator. The ball ramp operator includes first and second opposed annular rings having complimentarily configured opposed ramped recesses and rolling members disposed in the recesses. Relative rotation of the annular rings translates the annular rings axially to engage the clutch assembly and transfer torque from the input shaft to the output shaft. The first annular ring is coupled to the input shaft and the second annular ring is coupled to the output shaft. A third element disposed between the first annular ring and a shoulder of the input shaft has an engagement diameter selected to minimize torque variations between the torque transfer devices.

### CROSS REFERENCE TO RELATED APPLICATIONS

This application is a continuation-in-part application of and claims priority to U.S. patent application Ser. No. 12/179,120, filed Jul. 24, 2008, which claims the benefit of U.S. provisional application No. 60/953,237, filed Aug. 1, 2007.

### BACKGROUND OF THE INVENTION

1. Field of the Invention

The present invention generally relates to torque transfer devices. More specifically, the invention relates to electrically actuated clutches for mechanical power transmission systems especially useful in motor vehicle powertrains.

2. Description of Related Art

Torque transfer devices, of the electrically actuated clutch type, proportionally transfer torque from an input shaft to an output shaft upon the application of current to an electrical actuator. Each configuration requires the application of a certain amount of current to the electrical actuator to cause the clutch to transfer a given value of torque. Due to manufacturing and component variations between units of a given design, the actual relationship of current to torque will vary. This results in inconsistencies when engaging the torque transfer device. As result, too much or too little torque may be transferred causing, for example, hard or soft engagement of a secondary axle.

In view of the above, there exists a need to reduce torque variation and provide more consistent engagement of electrically actuated torque transfer devices in motor vehicle application.

### SUMMARY OF THE INVENTION

In satisfying the above need, as well as overcoming the enumerated drawbacks and other limitations of the related art, the present invention provides an electrically actuated torque transfer device for use in a motor vehicle. The torque transfer device includes an input shaft and at least one coaxially disposed output shaft. At least one modulating clutch assembly selectively couples the input shaft to the output shaft. The modulating clutch assembly includes an electrical clutch operator configured to engage a ball ramp operator to transfer torque from the input shaft to the at least one output shaft. The ball ramp operator has first and second opposed annular rings with complimentarily configured opposed ramped recesses and rolling members disposed in the recesses such that relative rotation of the annular rings results in relative axial translation between the annular rings (“cams”). The first annular ring (“base cam”) is selectively coupled to the input shaft through a primary clutch. The second annular ring (“apply cam”) is coupled to the output shaft. A third element is coaxially disposed between an axial face of the first annular ring and an axial shoulder of the input shaft is attached to the input shaft and frictionally engages the axial face of the first annular ring when a thrust force is generated.

In one embodiment, the third element has an axial surface with an engagement diameter selected to match the torque capabilities of the device in order to reduce torque variation. In one example, the engagement diameter is defined by in inner and outer diameters of the third element. In another example, the engagement diameter is defined by a chamfer. In yet another example, the engagement diameter is defined by a step diameter of a circumferential lip provided in the axial surface of the third element.

The modulating clutch assembly includes a primary clutch having input and output interleaved clutch plates. The input clutch plates are coupled to the input shaft and the output clutch plates are coupled to the first annular ring. The electrical clutch operator engages the primary clutch to engage the first annular ring with the input shaft to cause relative rotation between the annular rings to generate an axial compression force to axially compress a secondary clutch of interleaved clutch plates and frictionally transfer torque from the input shaft to the output shaft. The secondary clutch includes a set of first and second interleaved clutch plates. The first clutch plates are coupled to the input shaft and the second clutch plates are coupled to the output shaft.

The present invention also includes a method of assembling any of the electrically actuated torque transfer devices described herein. The method includes assembling a subassembly of the torque transfer device and characterizing a torque characteristic of the subassembly. The method also includes selecting a third element having an axial surface with an engagement diameter selected to match the desired torque characteristic of the subassembly, and installing the selected third element between an axial face of the first annular ring and an axial shoulder of the input shaft.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is an example of a schematic of a motor vehicle incorporating a torque transfer device according to the present invention

FIG. 2 is a sectional view of the torque transfer device according to the present invention;

FIG. 3 is front view of a third element of the torque transfer device of FIG. 2;

FIGS. 4A-4E show detail views of a portion of the torque transfer device of FIG. 2; and

FIG. 5 provides a step diagram of one method of reducing a torque variation in accordance with this invention.

### DETAILED DESCRIPTION

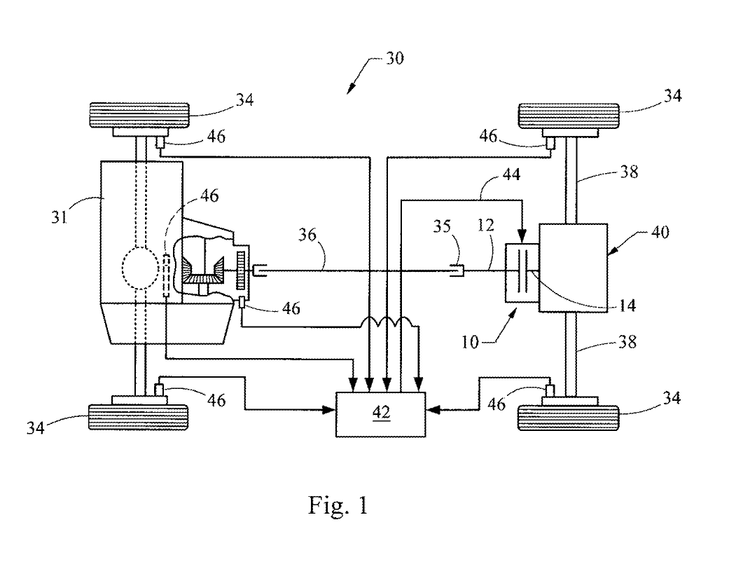

Referring now to the schematic of FIG. 1, an electrically actuated torque transfer device 10 according to the present invention is shown incorporated into a motor vehicle 30. The motor vehicle 30 includes a motive source 32 such as an internal combustion engine or electric motor. A plurality of wheels 34 are coupled to the motive source 32 through a drive member 36 and output members 38. Two output members 38 are shown coupled to the drive member 36 using any embodiment of the torque transfer device 10. In this example, a differential 40 couples the two output members 38 to the output shaft 14 of the device 10.

An electronic control unit (ECU) 42 is attached to the electrical clutch operator of the device 10 through, for example, a cable 44. The ECU 42 is configured to provide a range of electrical currents to the electrical clutch operator based on a desired amount of torque to be transferred from the drive member 36 to the output members 38. The desired amount of torque may be determined by the ECU 42 by reading a plurality of sensors 46 providing information regarding the operational state of the motor vehicle 30.

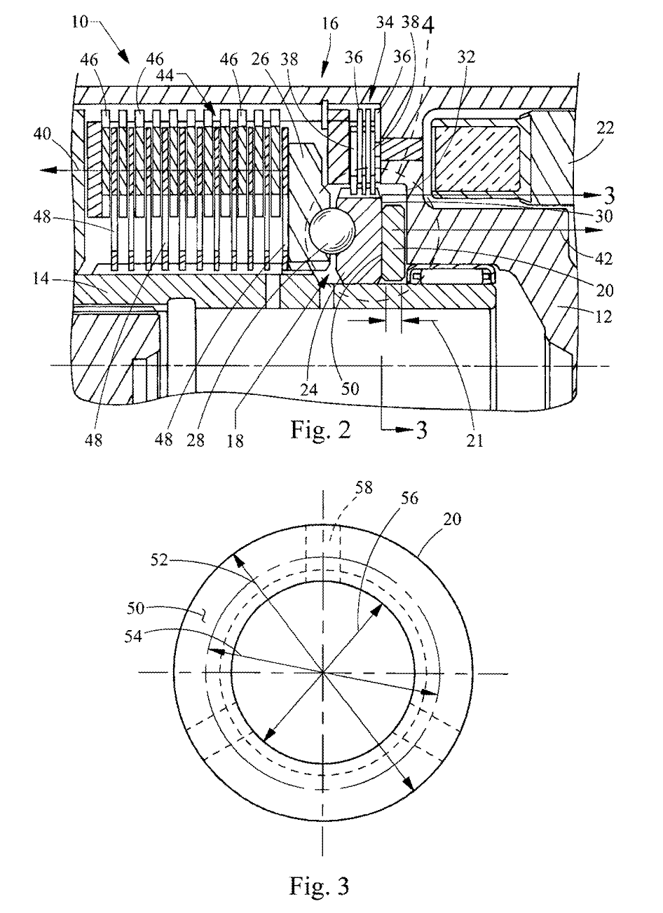

Referring now to FIG. 2, a partial section view of the electrically actuated torque transfer device 10 of the present invention is illustrated in more detail. As its primary components, the device 10 includes an input shaft 12 selectively coupled to a coaxially disposed output shaft 14 by a modulating clutch assembly 16 having a ball ramp operator 18. One example of a torque transfer device having one or more modulating clutch assemblies and including a ball ramp operator is disclosed in U.S. Pat. No. 6,905,008 to Kowalsky which is herein incorporated by reference. Another example is disclosed in U.S. Pat. No. 5,839,328 to Showalter which is also herein incorporated by reference.

The modulating clutch assembly 16 selectively transfers torque from the input shaft 12 to the output shaft 14 by activating an electrical clutch operator 22 of the modulating clutch assembly 16. The electrical clutch operator 22 engages the ball ramp operator 18 to transfer torque between the shafts 12 and 14 through primary and secondary clutches 34 and 44. The ball ramp operator 18 has first and second opposed annular rings 24 and 26 with complimentary, opposed and ramped recesses. Rolling members 28 are disposed within the recesses such that relative rotation of the annular rings 24 and 26 results in relative axial translation. As shown, the first annular ring 24 is selectively coupled to the input shaft 12 by the primary clutch 34. The second annular ring 26 is coupled to the output shaft 14 and is configured to actuate the secondary clutch 44. A third element 20 having an axial thickness 21 is coaxially disposed between an axial face 30 of the first annular ring 24 and an axial shoulder 32 of the input shaft 12. Optionally, the third element 20 is attached to the input shaft 12 and it engages the axial face 30 the first annular ring 24 upon relative axial translation of the annular rings 24 and 26. This basic arrangement including the third element is described by U.S. Pat. No. 6,837,351 which is hereby incorporated by reference.

In the example shown, actuating the electrical clutch operator 22 engages the first annular ring 24, preferably by means of the primary clutch 34, with the input shaft 12 resulting in relative rotation of the annular rings 24 and 26. The resulting axial translation of the second annular ring 26 generates an axial compression force indicated by the arrow 40 compressing a secondary clutch 44 having a set of first and second interleaved clutch plates 46 and 48 to frictionally transfer torque from the input shaft 12 to the output shaft 14 or vice versa. An axial or thrust reaction force indicated by the arrow 42 is generated opposing the axial compression force 40. The axial reaction force 42 acts against the axial shoulder 32 of the input shaft 12 through the first annular ring 24 and the third element 20. The first clutch plates 46 are coupled to the input shaft 12 and the second clutch plates 48 are coupled to the output shaft 14. The clutch plates 46 and 48 are coupled to their respective shafts 14 and 16 by, for example, a complimentary splines or similar features capable of allowing axial movement while transferring radial motion (i.e. torque). The reaction force 42 generates a rotational friction torque based on the coefficient of friction and the effective diameters of the faces of ring 24 and third element 20 which confront one another.

The electrical clutch operator 22 engages the first annular ring 24 with the input shaft 12 through the primary clutch 34 having input and output interleaved clutch plates 36 and 38. The input clutch plates 36 are coupled to the input shaft 12 and the output clutch plates 38 are coupled to the first annular ring 24 similar to the first and second clutch plates 46 and 48. The electrical clutch operator 22 includes, but is not limited to, an electromagnetic coil configured to magnetically compress the interleaved clutch plates 36 and 38 to frictionally engage the first annular ring 24 with the input shaft 12 to cause the above mentioned relative rotation between the first and annular rings 24 and 26.

Other instances of the electrical clutch operator 22 may have any other appropriate device for engaging the first annular ring 24 with the input shaft 12. In addition to the electromagnetic example described above, other examples include, but are not limited to, electromechanical devices and electrohydraulic devices. The electromechanical device may include any appropriate electric motor configured to mechanically compress the interleaved clutch plates 36 and 38. The electrohydraulic device may include an electric pump and/or an electrically actuated valve to hydraulically compress the interleaved clutch plates 36 and 38.

Due to normal manufacturing variations between production units of the torque transfer devices 10, the torque transfer capabilities of each unit will vary with certain product characteristics. Selection of an engagement diameter 54 of the third element 20 is a way of tailoring the torque characteristics of each unit. To provide a desired torque characteristic, an appropriate third element 20 is selected to match the torque characteristics with the envisaged target torque of the device 10.

Turning now to FIG. 3, a front view of the third element 20 is shown in more detail. The third element 20 has an axial surface 50 with an outer diameter 52. The engagement diameter 54 is defined as an intermediate diameter between the outer diameter 52 and an inner diameter 56. The engagement diameter 54 is a diameter which, when considered with the coefficient of friction between the confronting surfaces and the normal (thrust) applied force, characterizes the frictional torque characteristics at the interface of third element 20 and ring 24. The engagement diameter may be close to the radial midpoint between diameters 52 and 56 or slightly larger than the midpoint. Engagement diameter 54 is affected by both diameters 52 and 56. In the following, the terms “engagement diameter” and “effective diameter” are used interchangeably.

The effective diameter is the diameter that, if the contact between the third element 20 and the annular ring 24 were limited to a narrow circular line, would be the diameter of the circular line that would result in the same torque transfer. The following definition is typically used for dimensioning of friction brakes in which a brake pad contacts a brake disk:

D_{eff}=(Dₒ+Dᵢ)/2,

where D_{eff} is the effective diameter, Dₒ is the outer diameter of the contact surface, and Dᵢ is the inner diameter of the contact surface, all measured from the axis of rotation.

Another definition of the effective diameter is frequently used for ring-shaped contact surfaces:

D_{eff}=[2(Dₒ³−Dᵢ³)]/[3(Dₒ²−Dᵢ²)],

This definition results in slightly larger values for D_{eff}. In reality, however, the differences are small and can be compensated with a compensation factor k as explained below.

The resulting torque τ can be calculated as:

τ=k·F·μ_{f}·D_{eff}/2,

where k is an empirical correction factor accounting for systemic deviations of real devices from an ideal device, F is the axial clamping force, and μ_{f} is the coefficient of friction between the third element 20 and the annular ring 24. While the compensation facto k may differ for different torque ranges, the devices introduced by the present invention all operate within one torque range, for which a constant compensation factor k may be assumed.

Notably, according to the model, the effective diameter D_{eff} is independent of the area of the contact surface. For torque transfer devices according to the present invention, this model closely reflects reality. Accordingly, the effective diameter, also called the engagement diameter, increases if the outer diameter or the inner diameter or both diameters of the contact surface increase. Conversely, the engagement diameter decreases if the outer diameter or the inner diameter or both diameters decrease. Should real measurements indicate that the torque transfer of a production line is in fact dependent on the contact area, the compensation factor may be chosen as a parameter that is correlated with the inner or outer diameters, Dᵢ or Dₒ.

Also, while the torque is largely unaffected by the area of the contact surface, the contact area has an influence on wear and durability, where a larger contact area is desirable because less pressure is exerted so that the wear on the friction surfaces progresses at a slower pace.

One or more projections 58 (shown as hidden lines) opposite the axial surface 50 may be provided to engage complimentary recesses (not shown) in the axial shoulder 32 of the input shaft 12 such that the third element 20 is attached to and rotates with the input shaft 12 to prevent relative rotation therebetween.

The dimensions of the third element 20 depend on the needs of each particular application. In one non-limiting example, the engagement diameter 52 may be in the range of about fifty-four to fifty-eight millimeters. Preferably, the third element 20 is made of any low friction, low wear compound. Some non-limiting examples of such a compound include polyamide-imide resins and fluoropolymer resins such as ppolytetrafluoroethylene (PTFE).

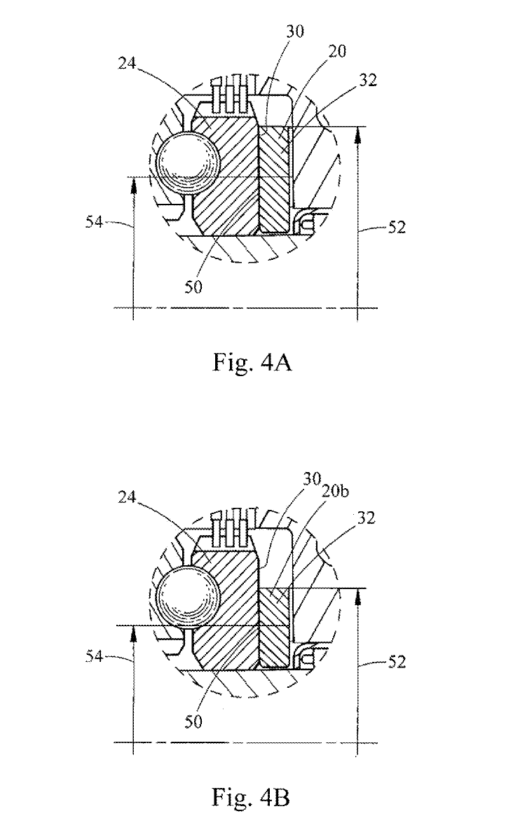

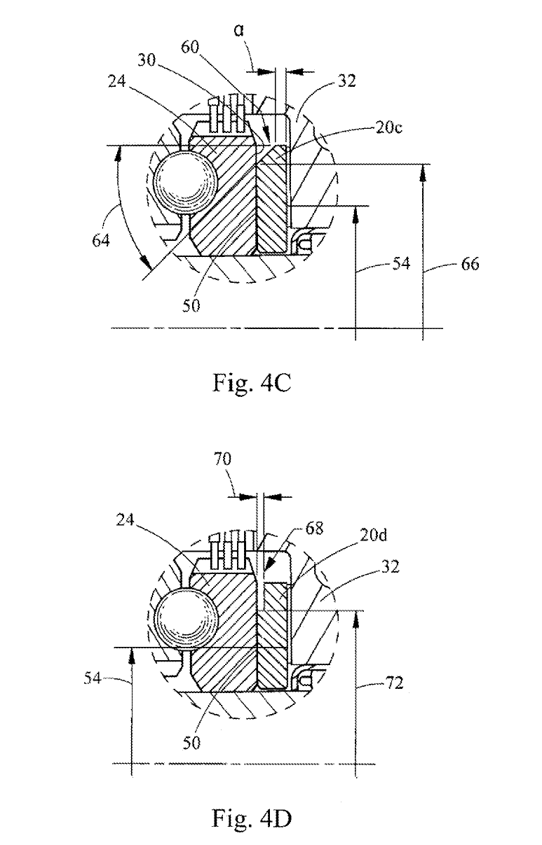

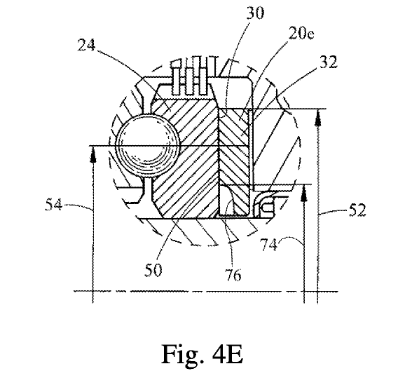

Turning now to FIGS. 4A-4E, various examples of the third element 20 are shown in a partial section along with the first annular ring 24 and the axial shoulder 32 of the input shaft 12. FIG. 4A shows the third element 20 of FIG. 2 where the engagement diameter 54 is adjusted based upon the outer diameter 52 being selected such that almost the entire axial face 30 of the first annular ring 24 engages the axial surface 50. FIG. 4B shows a third element 20b having a reduced outer diameter 52 such that only a portion of the axial face 30 is engaged by the axial surface 50. FIGS. 4C and 4D achieves a similar effect by providing a chamfer 60 in FIG. 4C and a circumferential lip 68 in FIG. 4D also adjusts outer diameter 52 resulting in only a portion of the axial face 30 engaging the axial surface 50. The chamfer 60 is defined by a chamfer angle 64 and a chamfer diameter 66 and the circumferential lip 68 is defined by a notch depth 70 and a step diameter 72.

In contrast to FIGS. 4B through 4D, FIG. 4E illustrates an increase in engagement diameter 54 of the third element 20e by providing a chamfer, step, or other axial recess 76 that increases the inner diameter 74. The axial face 30 of the annular ring 24 limits the maximum outer diameter of the contact area. Therefore, a further increase of the outer diameter 52 of the third element will not result in an increase of the engagement diameter 54. Because the engagement diameter 54 corresponds approximately to the mean value of outer diameter 52 and inner diameter 74, an increase of the inner diameter 74 results in an increase of the engagement diameter 54.

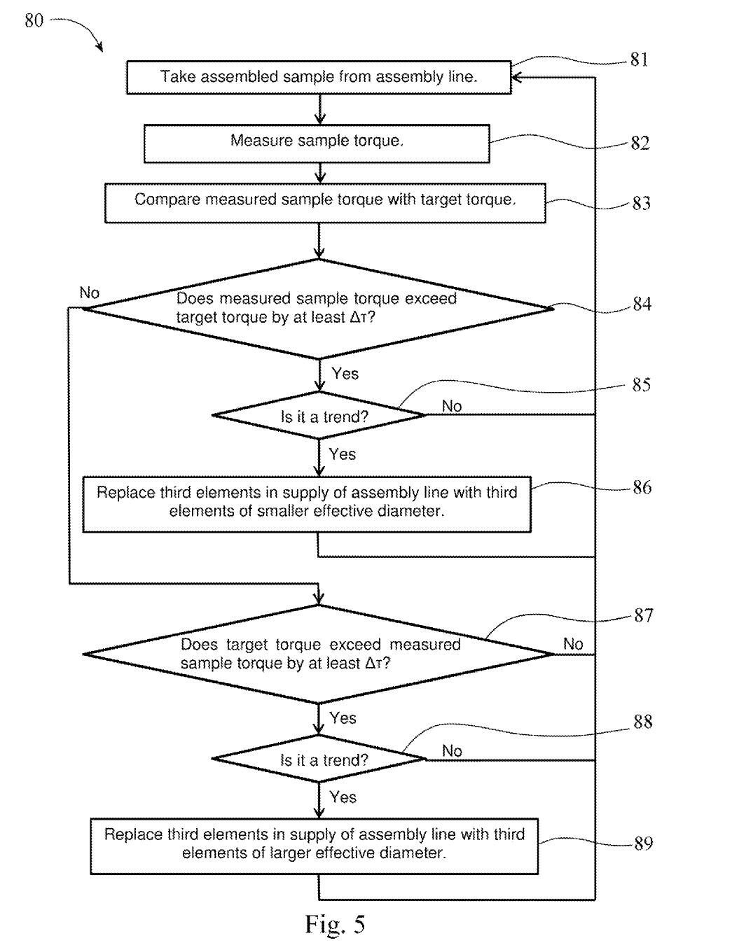

Turning now to FIG. 5, one example of a method for reducing the torque variance of a production line of torque transfer devices is described and designated at 80. The method 80 includes a first step 81 of taking a sample torque transfer device after it has been fully assembled in an assembly line. For simplification of this example, it is assumed that the sample includes a third element 20 as shown in FIG. 4a. In a second step 82, the sample torque transfer device undergoes testing during which the torque transfer of the sample is measured. This measurement may involve a measurement of relative deceleration between the axial shoulder 32 and the annular ring 24 under specified axial forces pressing the axial shoulder 32 against the annular ring 24. In a next step 84 it is verified whether the measured torque of the sample exceeds a target torque by at least a threshold value Δτ. The target torque is typically a nominal mean value dictated by customer specification. The customer specification also determines an allowable variance for permissible deviations of the actually transferred torque from this nominal mean value. The threshold value Δτ is a value that is smaller than or equal to the allowable variance. The threshold value Δτ is preferably chosen to be significantly smaller than the allowable variance for reducing variations in the actual transferred torque among the torque transfer devices leaving the assembly line, as will be explained below. For example, the threshold value Δτ may be chosen to be about half of the allowable variance. If the customer specification, for example, allows for a variance of about 10% of the target torque, the threshold value Δτ may be about 5% of the target torque.

If in step 84 the measured torque of the sample exceeds a target torque by at least Δτ, this measurement alone does not necessarily change the third element used for subsequent torque transfer devices. The measurement may be an outlier and have no significance for the entire batch being assembled. If, however, a predetermined number of samples taken off the assembly line show similar deviations from the target torque, it is established in step 85 that the increased torque constitutes a trend. If it is determined that the deviation is part of a trend, the assembly line is furnished in step 86 with third elements having a smaller effective diameter for subsequently assembled torque transfer devices, for example with third elements 20b of FIG. 4B, 20c of FIG. 4C, or 20d of FIG. 4D. The torque transfer performance of the subsequently assembled torque transfer devices with the changed third elements is then tested on samples by returning to step 81.

If in step 85 the currently measured torque that exceeds the threshold value Δτ is not determined to be part of a trend, no changes are made at this time to the third elements fed to the assembly lines, and sample measurements continue by returning to step 81.

If in step 84 the measured torque of the sample does not exceed the target torque by at least Δτ, the method proceeds to step 87, where it is determined whether the measured sample torque lies below the target torque by at least the threshold value Δτ.

Notably, while the illustrative method shown in FIG. 5 uses identical threshold values Δτ for the upward and downward deviations, two different threshold values may be chosen. For example, the threshold value of step 87 may be smaller than the threshold value of step 84. Also, the two step sequences 84 through 86 and 87 through 89 may be swapped or performed simultaneously without leaving the scope of the present invention.

In analogy to step 85, if it is determined in step 87 that the target torque exceeds the measured torque of the sample by at least Δτ, step 88 evaluates whether the deviation is part of a trend by looking at previous samples. If the deviations show consistently reduced torque measurements relative to the target torque, it is determined in step 87 that the deviation is part of a trend. If it is determined that the deviation is part of a trend, the assembly line is furnished in step 89 with third elements having a larger effective diameter for subsequently assembled torque transfer devices, for example with third elements 20e of FIG. 4E. The torque transfer performance of the subsequently assembled torque transfer devices with the changed third elements is then tested on samples by returning to step 81.

Where the outside diameter 52 of the contact surface 30 between third element 20 and annular ring 24 cannot be enlarged, an increase of the effective diameter 54 can be achieved by increasing the inner diameter 74 of the contact area 30, for example in the form of the chamfer 76.

If the currently measured torque below the target torque by at least the threshold value Δτ is not determined in step 88 to be part of a trend, no changes are made at this time to the third elements fed to the assembly line, and sample measurements continue by returning to step 81.

While the method 80 depicted in FIG. 5 designates the tested torque transfer devices as “samples,” is well within the scope of the present invention to treat every torque transfer device as a sample so that every individual device is tested. But it is also envisioned to test at any other frequency, for example every fiftieth device. Further, the number of devices with similar deviations that establish a trend may differ based on the frequency of samples being taken and on empirically obtained data observing typical torque changes within a batch of manufactured devices. A trend may, for example, be caused by a batch of parts from a new box or pallet supplied to the assembly line after a previous pallet or box is depleted. If the new batch has a different size or characteristics within the given tolerances, the torque transferred by a torque transfer device comprising a part of the new batch may be different than the torque transferred by a torque transfer device with a part of the depleted batch. Such a change results in a trend that is compensated by the described method 80.

The assembly line may be moving a dozen or more torque transfer devices at the same time, each device at a different stage of assembly. While a finished device is tested, a number of devices are still in the process of being assembled with substantially identical part as the one that is currently tested. Therefore, selecting threshold values Δτ significantly smaller than the allowed variance allows for the observation of trends and for changing the third element only for devices that have not yet reached the stage at which the third element is inserted. The torques of devices with torques outside the threshold values still lie within the allowable variances so that a correction is not necessary on devices that have already been assembled.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. An electrically actuated torque transfer device for use in a motor vehicle, the torque transfer device comprising:
an input shaft and at least one output shaft selectively coupled to the input shaft;
at least one modulating clutch assembly selectively coupling the input shaft to the output shaft, the modulating clutch assembly including an electrical clutch operator configured to engage a ball ramp operator;
the ball ramp operator including first and second opposed annular rings having complimentarily configured opposed and ramped recesses with rolling members disposed in the recesses such that relative rotation of the first and second annular rings causes relative axial translation of the first and second annular rings, the first annular ring being coupled to the input shaft and the second annular ring being coupled to the output shaft; and
a third element defining an axial thickness and an axial surface having an engagement diameter being coaxially disposed between the first annular ring and the input shaft, the axial surface of the third element frictionally engaging the axial face of the first annular ring upon the relative axial translation of the annular rings, and the engagement diameter being selected to provide desired torque transfer characteristics for the torque transfer device.

2. The torque transfer device of claim 1, wherein the third element is disposed between an axial face of the first annular ring and an axial shoulder of the input shaft.

3. The torque transfer device of claim 1, wherein the third element is attached to and rotates with the input shaft.

4. The torque transfer device of claim 1, wherein the axial surface of the third element engages only a portion of the axial face of the first annular ring.

5. The torque transfer device of claim 1, wherein the engagement diameter is in a range which is determined for every individual application of the torque transfer device.

6. The torque transfer device of claim 1, wherein the engagement diameter is adjusted by variations in the outer diameter of the third element.

7. The torque transfer device of claim 1, wherein the engagement diameter is adjusted by variations in the chamfer inner diameter of a chamfer provided at an intersection of the axial surface and an outer diameter of the third element.

8. The torque transfer device of claim 1 wherein the engagement diameter is adjusted by variations in a step diameter of a circumferential lip provided in the axial surface of the third element.

9. The torque transfer device of claim 1, wherein the modulating clutch assembly further includes a primary clutch having a set of input and output interleaved clutch plates, the input clutch plates being coupled to the input shaft and the output clutch plates being coupled to the first annular ring, the electrical clutch operator engaging the primary clutch to cause relative rotation between the annular rings to generate an axial compression force to axially compress a secondary clutch including a set of interleaved clutch plates to frictionally transfer torque from the input shaft to the output shaft.

10. The torque transfer device of claim 9, wherein an axial reaction force is generated opposite the axial compression force, the axial reaction force acting against the axial shoulder of the input shaft through the first annular ring and the third element.

11. A method of reducing a torque variation of a series of electrically actuated torque transfer devices for use in a motor vehicle, the method comprising:
assembling a first torque transfer device, the first torque transfer device including an input shaft and at least one output shaft selectively coupled to the input shaft, at least one modulating clutch assembly selectively coupling the input shaft to the output shaft, the modulating clutch assembly including an electrical clutch operator configured to engage a ball ramp operator, the ball ramp operator including first and second opposed annular rings having complimentarily configured opposed and ramped recesses with rolling members disposed in the recesses such that relative rotation of the annular rings causes relative axial translation of the annular rings, the first annular ring being selectively coupled to the input shaft by a primary clutch having a third element with an axial surface defining a first engagement diameter providing a first torque transfer characteristic of the torque transfer device and the second annular ring being coupled to the output shaft and engaging a secondary clutch;
characterizing a torque characteristic of the subassembly;
selecting a third element having an axial surface with a second engagement diameter selected to provide a desired second torque transfer characteristic of the torque transfer device; and
installing the selected third element between the first annular ring and the input shaft of a subsequently assembled torque transfer device.

12. The method of claim 11, wherein the third element of the installing step is attached to an axial shoulder of the input shaft and frictionally engages an axial face of the first annular ring.

13. The method of claim 12, wherein the axial surface of the third element of the installing step engages only a portion of the axial face of the first annular ring.

14. The method of claim 11, wherein the engagement diameter of the third element of the selecting step is in a range which is determined for every individual application of the torque transfer device.

15. The method of claim 11, wherein the engagement diameter of the third element of the selecting step is defined by adjusting an outer diameter of the third element.

16. The method of claim 11, wherein the engagement diameter of the third element of the selecting step is defined by a chamfer diameter of a chamfer provided at an intersection of the axial surface and an outer diameter of the third element.

17. The method of claim 11, wherein the engagement diameter of the third element of the selecting step is defined by a step diameter of a circumferential lip provided in the axial surface of the third element.

18. The method of claim 11, wherein the third element with the second engagement diameter is selected after a measuring a plurality of first torque characteristics and determining that the first torque characteristics follow a trend.
